(19) United States
(12) Patent Application Publication
(10) Pub. No.: US 2004/0028262 A1
(43) Pub. Date: Feb. 12, 2004

(54) Optical system of fingerprint image capture apparatus

(76) Inventors: Kuo-Liang Lin, Taipei (TW); Chiao-Hsin Chien, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,717

(22) Filed: Aug. 9, 2002

(51) Int. Cl. G06K 9/00

(52) U.S. Cl. 382/127

(57) ABSTRACT

An optical system of fingerprint image capture apparatus comprises an optical platen substantially in a flat shape, a source light, and an image sensor. The optical platen includes a generally planar contact face having a dull rough surface against which a finger is placed, and a generally planar viewing face at the side of which is placed the image sensor and the light source. An incident light from the light source that strikes a region of the contact surface touched by a fingerprint ridge is scattered and passes through the viewing face to be substantially captured by the image sensor. An incident light that strikes a region of the contact face corresponding to a fingerprint valley is scattered and further passes out of the optical prism by refraction. The fingerprint ridge thereby appears as brighter regions and the fingerprint valley as darker regions.

### BACKGROUND OF INVENTION

1. Field of the Invention

The invention relates generally to image capture apparatus and, more particularly, to the optical system of a fingerprint image capture apparatus.

2. Description of the Related Art

Fingerprint identification systems usually require the use of an image capture apparatus such as a video camera to pick up the image of the fingerprint. However, a simple photograph of the same fingerprint may be used to obtain the same image at the output of the image capture apparatus, which consequently defrauds the fingerprint identification system. Some fingerprint image capture apparatus known in the prior art are therefore provided with a triangular optical prism in order to ascertain that a real finger is indeed being placed before the image capture apparatus.

FIG. 1 and FIG. 2 are schematic drawings that illustrate a traditional optical system and its mechanism used in a fingerprint image capture apparatus of the prior art. As illustrated, an optical system of the prior art includes a triangular transparent optical prism 10, a light source 13, and an image sensor 15. The optical prism 10 includes a contact face 10a against which a finger 20 is placed, a light receiving face 10b that receives light from the light source 13, and a viewing face 10c through which image light reflected from the fingerprint emerges out of the prism 10 to be captured via the image sensor 15. All the faces 10a, 10b, 10c are planar and smooth to enable an adequate light passage as described below.

As illustrated in the enlarged view of FIG. 1B, an incident light L1 that passes into the prism 10 and strikes a region of the contact face 10a where a fingerprint ridge 22 is scattered and/or absorbed, which produces a scattered light SL1. In contrast, an incident light L2 that strikes a region of the contact face 10a corresponding to a fingerprint valley 204, at the condition the incidental angle is greater than the critical angle of reflection, is totally reflected into a reflected light RL 2. The reflected light RL2 emerges out of the prism 10 through the viewing face 10c to be captured by the image sensor 15.

Since the incident light L2, striking the region corresponding to the fingerprint valley 24, is totally reflected, while the incident light L1, striking the region corresponding to the fingerprint ridge 22, is scattered and/or absorbed, the fingerprint valley 24 therefore appears brighter and the fingerprint ridge 22 darker on the image formed in the image sensor 15.

A disadvantage of the above optical system of the prior art is that the image may not be formed entirely on the image sensor, and the image hence formed may be negatively reduced. Moreover, the use of an optical prism triangularly shaped restricts the possibility of mounting arrangements of the optical system within the image capture apparatus. This may be particularly disadvantageous when the dimensional size of the image capture apparatus has to be reduced.

### SUMMARY OF INVENTION

An aspect of the invention is therefore to provide an optical system of fingerprint image capture apparatus that has a reduced size so as to enable a dimensional reduction of the image capture apparatus.

Another aspect of the invention is to provide an optical system of fingerprint image capture apparatus that allows the formation of a larger fingerprint image.

Yet, another aspect of the invention is to provide an optical system of fingerprint image capture apparatus that allows a flexible configuration of the image capture apparatus to pick up either a fingerprint image or an environment image as a typical video camera.

To accomplish the above and other objectives, the invention provides an optical system of fingerprint image capture apparatus that comprises an optical platen substantially in a flat shape, a source light, and an image sensor. The optical platen includes a contact face having a rough surface against which a finger is placed, and a viewing face at the side of which is placed the image sensor. The light source emits a light that passes into the optical platen and strikes the contact face. An incident light that strikes a region of the contact surface touched by a fingerprint ridge is scattered via the irregular surfaces of both contact face and fingerprint ridge. An incident light that strikes a region of the contact face corresponding to a fingerprint valley is scattered and further passes out of the optical prism by refraction and undergoes multiple light refraction and scattering between the fingerprint valley and the contact face. The scattered light from the region of the contact face corresponding to the fingerprint ridge passes out of the optical platen via the viewing face and is substantially captured by the image sensor. The light scattered and refracted through the region of the contact face corresponding to the fingerprint valley does not substantially attain the image sensor. The intensity of image light from the fingerprint valley being substantially lower than the intensity of image light from the fingerprint ridge, the fingerprint valley therefore appears as darker regions while the fingerprint ridge appears as brighter region on the image formed in the image sensor. Hence formed, the fingerprint image has a larger size.

The above optical system of fingerprint image capture apparatus is installed within an electronic device in such a manner that the optical platen is movably mounted to an image capture window of the electronic device. Via its movable mount, the optical platen is able to cover and uncover the image capture window. When the optical platen covers the image capture window, the optical system is placed in fingerprint capture configuration in which a fingerprint image can be captured. When the optical platen uncovers the image capture window, the optical system is placed in a video camera configuration in which farther environment images can be captured.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a schematic view illustrating a traditional optical system of a fingerprint image capture apparatus known in the prior art;

FIG. 1B is a schematic view illustrating the mechanism of the traditional optical system of fingerprint image capture apparatus;

FIG. 2A is a schematic view illustrating an optical system of a fingerprint image capture apparatus according to an embodiment of the invention;

FIG. 2B is a schematic view illustrating the mechanism of an optical system of a fingerprint image capture apparatus according to an embodiment of the invention; and

FIG. 3 is a schematic view illustrating the application of an image capture apparatus provided with an optical system according to an embodiment of the invention.

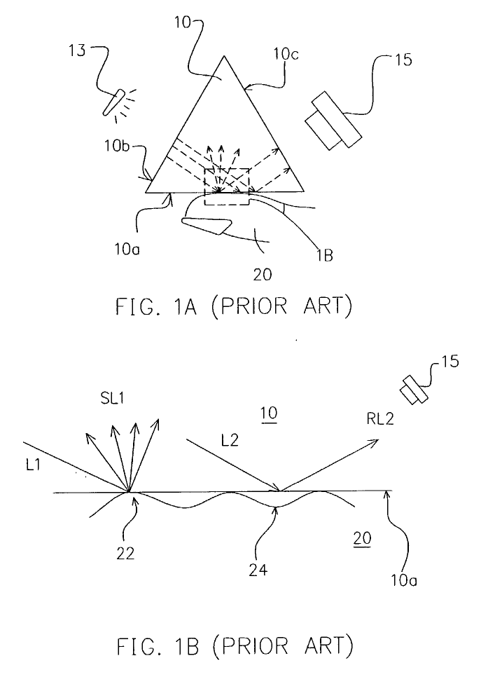

### DETAILED DESCRIPTION

The following detailed description of the embodiments and examples of the present invention with reference to the accompanying figures is only illustrative and not limiting. The figures simply draw the elements with their respective general shape and do not constitute a representation in scale, wherein only the elements essential to the understanding of the invention are represented, and other elements and parts known in the prior art are omitted. Wherever possible in the following description and accompanying drawings, like reference numerals and symbols will refer to like elements and parts unless otherwise described.

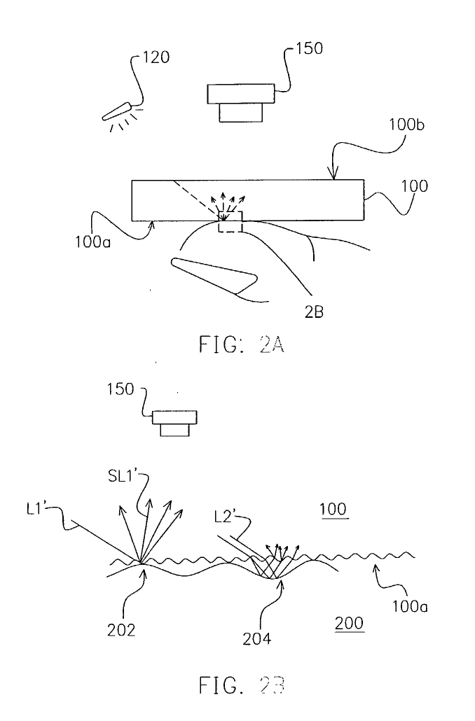

Reference now is made to FIG. 2A and FIG. 2B to describe a fingerprint image pickup apparatus according to an embodiment of the invention. FIG. 2A is a schematic general drawing that illustrates the optical system of the fingerprint image pickup apparatus according to the invention. FIG. 2B is an enlarged view of the region 2B in FIG. 2A. As schematically illustrated in FIG. 2A, the optical system comprises an optical platen 100, a light source 120, and an image sensor 150. A lens assembly (not shown) may be further installed between the image sensor 150 and the platen 100 as typically achieved in the prior art.

The light source 120 is preferably comprised of light-emitting diodes (LED) disposed in, for example, in a single row. However, it will be readily appreciated that other types of light source to provide an incident light on the platen 100 may be also adequate.

The image sensor 150 captures image lights from the platen 100 and converts them to electric signals. The image sensor 150 can include, for example, a charge coupled device (CDD), a complementary metal oxide semiconductor (CMOS) device, or a contact image sensor (CIS) as well known in the art.

The optical platen 100 is made of transparent glass, plastics, or other adequate transparent material. The optical platen 100 is preferably formed in a substantially flat shape. As illustrated, such a shape can be, for example, a solid having a general shape close to that of a parallelepiped prism with two opposite large faces 100a, 100b that are substantially parallel. Although the faces 100a, 100b are drawn parallel in the FIG. 2A, they may be slightly inclined with respect to each other to obtain an optimal orientation with respect to the different incident and emergent lights. The face 100a is formed from a generally planar surface that is further treated in a manner to exhibit a dull rough aspect, such as shown in the enlarged view of FIG. 2B. The adequate surface irregularity is achieved via various methods such as, for example, adequate grinding. The face 100a constitutes a contact face against which a finger 200 is placed for fingerprint image capture. The face 100b is formed from a generally planar surface that is substantially smooth and constitutes a viewing face at the side of which the image sensor 150 is placed, facing the viewing face 100b. In the illustrated embodiment, the light source 120 is also adequately placed on the same side of the image sensor 150.

To form a fingerprint image on the image sensor 150, the finger 200 is placed against the contact face 100a of the optical platen 100 with the fingerprint in contact with the irregular surface thereof. As illustrated in FIG. 2B, an incident light (L1′, L2′) emitted from the light source 120 passes into the platen 100 and strikes the contact face 100a. However various types of incident light may be adequate, an incoherent incident light is preferable in this embodiment.

In a region of the contact face 100a where a fingerprint ridge 202 touches the rough surface of the contact face 100a, the incident light L1′ is substantially scattered in multiple directions due to the irregular surfaces of both contact face 10a and fingerprint ridge 202, producing scattered light SL1′. A part of the scattered light SL1′ emerges out of the platen 100 via the viewing face 100b and is captured by the image sensor 150. In a region of the contact face 100a corresponding to a fingerprint valley 204, a portion of the incident light L2′ is scattered due to the irregular surface of the contact face 100a, while another portion of incident light L2′ passes out of the platen 100 by refraction. This portion of refracted light is scattered and/or absorbed on the surface of the fingerprint valley 204, a scattered portion being re-directed toward the irregular surface of the contact face 100a and again undergoes scattering and refraction through the contact face 100a.

As a result of the above multiple light scattering and refraction at the region of fingerprint valleys 204, the intensity of light from fingerprint valleys 204 is substantially less than the intensity of light from fingerprint ridges 202. Consequently, fingerprint valleys 204 appear as darker regions while fingerprint ridges 202 appear as brighter regions in the image of the fingerprint.

With the above optical system, an advantage is the obtention of an image that is larger than that of the prior art. In order to obtain a better contrast between the ridges 202 and the valleys 204, the image of the fingerprint can be further post-treated via specific image processing.

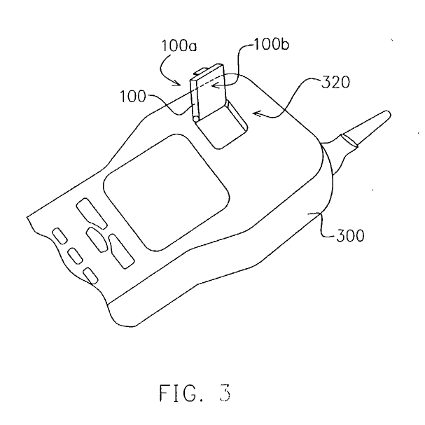

Referring now to FIG. 3, a perspective view schematically illustrates an example of implementation of the above optical system of the invention. As illustrated, a fingerprint image capture apparatus including the optical system as described above may be installed within, for example, a mobile phone 300. The mobile phone 300 includes an image capture window 320 to which the optical platen 100 is pivotably mounted, with the contact face 100a turned outward and the viewing face 100b turned inward the interior of the mobile phone where the image sensor 150 is mounted. To capture an image of a fingerprint, the platen 100 is turned in a manner to cover the window 320, and the finger is placed against the contact face 100a.

The incorporation of a fingerprint image capture apparatus within a mobile phone as described above can achieve, for example, an internal locking system in which the mobile phone is unlocked by fingerprint identification.

By turning the platen 100 in a manner to uncover the window 320, the fingerprint image capture apparatus further can be configured as a typical video camera to pickup farther environment images. This video camera may pickup, for example, the user's image to achieve an audio/video communication.

Since the contact surface with the fingerprint must usually have a minimum size to ensure a sufficiently large image of the fingerprint, in comparison with the optical prism of the prior art, the substantially flat optical platen of the invention therefore reduces the size of the optical system. As a result, the size of the fingerprint image capture apparatus can be also reduced. Furthermore, via an adequate movable mount of the flat optical platen, the optical system of the invention favorably allows a fingerprint capture configuration or a video camera configuration.

It should be apparent to those skilled in the art that other structures that are obtained from various modifications and variations of various parts of the above-described structures of the invention would be possible without departing from the scope and spirit of the invention as illustrated herein. For example, the above description illustrates an implementation of the fingerprint image capture apparatus within a mobile phone. It will be readily appreciated that the fingerprint image capture apparatus can be implemented within other types of devices with the advantages as described above. Therefore, the above description of embodiments and examples only illustrates specific ways of making and performing the invention that, consequently, should cover variations and modifications thereof, provided they fall within the inventive concepts as defined in the following claims.

1. An optical platen used within an optical system of a fingerprint image capture apparatus, the optical platen comprising a contact face provided with a dull rough surface against which a finger is placed to pickup a fingerprint image, and an opposite viewing face exhibiting a smooth surface through which a fingerprint image light, resulted from a scattering of an incident light striking the contact face, emerges out of the optical platen to be captured by an image sensor.

2. The optical platen of claim 1, wherein the material of the optical platen includes transparent glass or plastics.

3. The optical platen of claim 1, wherein the contact face has an adequate roughness to respectively enable light scattering at the region of the contact face touched by a fingerprint ridge, and light scattering and refraction at the region of the contact face corresponding to a fingerprint valley, thereby the fingerprint ridge appears as a brighter region and the fingerprint valleys as a darker region on a formed fingerprint image.

4. The optical platen of claim 1, wherein the contact face and the viewing face are generally planar.

5. The optical platen of claim 1, wherein the optical platen has a general shape that is substantially flat.

6. An optical system for fingerprint image capture, the optical system being installed within an electronic device that includes an image capture window, the optical system comprising:
an optical platen, including a contact face provided with a dull rough surface against which a finger is placed to pickup a fingerprint image, and an opposite viewing face exhibiting a smooth surface, wherein the optical platen is mounted to the image capture window with the contact face outwardly oriented and the viewing face inwardly oriented;
a light source, placed proximate to the viewing face, and emitting an incident light that passes into the optical platen and strikes the contact face; and
an image sensor, placed proximate to the viewing face of the optical platen to receive an emerging image light resulted from a scattering of the incident light on the contact face against which the finger is placed.

7. The optical system of claim 6, wherein the material of the optical platen is made of transparent glass or plastics.

8. The optical system of claim 6, wherein the contact face has an adequate roughness to respectively enable light scattering at the region of the contact face touched by a fingerprint ridge, and light scattering and refraction at the region of the contact face corresponding to a fingerprint valley, thereby the fingerprint ridge appears as a brighter region and the fingerprint valleys as a darker region on a fingerprint image formed via the image sensor.

9. The optical system of claim 6, wherein the contact face and the viewing face are generally planar.

10. The optical system of claim 6, wherein the optical platen has a general shape that is substantially flat.

11. The optical system of claim 6, wherein the optical platen is further movably mounted to the image capture window in a manner to be capable of covering and uncovering the image capture window, thereby the optical system is enabled to be configured to a fingerprint image capture configuration when the optical platen covers the image capture window, and to a farther environment image capture configuration as a video camera optical system when the optical platen uncovers the image capture window.

12. The optical system of claim 6, wherein the light source includes light-emitting diodes (LED).

13. The optical system of claim 6, wherein the image sensor includes a charge coupled device (CDD), a complementary metal oxide semiconductor (CMOS) device, or a contact image sensor (CIS).

14. An application of an optical system according to claim 11, wherein the optical system is installed within a mobile phone to achieve an internal image capture apparatus that is enabled to be configured to pickup either a fingerprint image or a farther environment image.
